(19) United States
(12) Patent Application Publication
(10) Pub. No.: US 2016/0091760 A1
(43) Pub. Date: Mar. 31, 2016

(54) BACKLIGHT DEVICE AND LIQUID CRYSTAL DISPLAY

(71) Applicant: Panasonic Intellectual Property Management Co., Ltd., Osaka (JP)

(72) Inventors: MOTONARI OGURA, Osaka (JP); MITSUHIRO MIURA, Hyogo (JP); TAKAHIRO NASU, Osaka (JP); TOMOHIRO SEKIGUCHI, Osaka (JP)

(21) Appl. No.: 14/859,235

(22) Filed: Sep. 18, 2015

(30) Foreign Application Priority Data
Sep. 25, 2014 (JP) 2014-195445
Aug. 25, 2015 (JP) 2015-165328

(51) Int. Cl. G02F 1/1335; F21V 13/12; F21V 13/10; F21V 7/00

(52) U.S. Cl. CPC G02F 1/133611; G02F 1/133603; G02F 1/133605; F21V 7/0066; F21V 13/12; F21V 13/10; F21Y 2105/001

(57) ABSTRACT

A backlight device in the present disclosure is equipped with: a plurality of LEDs disposed lengthwise and widthwise; a substrate on which the plurality of LEDs are mounted; and a light-blocking member configured to prevent a predetermined amount of part of light from passing through, wherein the part of light is part of light emitted from an LED, of the plurality of LEDs, disposed on an outermost circumference and is emitted to an outer circumferential side.

### BACKGROUND

1. Field of the Invention

The present disclosure relates to a direct type LED backlight device which is used for a liquid crystal display in a liquid crystal television, a liquid crystal display monitor, and the like.

2Description of the Related Art

The LED backlight device is typically configured such that a backlight device as a surface light source is disposed on the rear side of a flat liquid crystal display panel; and there are two light emission types of the backlight device, which are an edge type and a direct type.

A backlight device of the edge type is a backlight device of a method in which LEDs (light emitting diodes) are arranged on an edge part of a backlight device and light is emitted to a front surface through a light guide plate. In contrast, a backlight device of the direct type is a backlight device of a method in which the LEDs are arranged immediately back of the liquid crystal display panel and the light is directly emitted to the front surface. A backlight device of the direct type is disclosed in PTL 1, for example.

When the edge type and the direct type are compared, the edge type has a feature of being more suitable for thin LED backlight devices but being higher in cost, and the direct type has a feature of making LED backlight devices thicker but being lower in cost.

### CITATION LIST

### Patent Literature

PTL 1; Unexamined Japanese Patent Publication No. 2011-90977

### SUMMARY

The present disclosure provides a direct type LED backlight device and a direct type liquid crystal display in which unevenness of brightness is reduced and uniformity of brightness is improved.

A backlight device in the present disclosure is equipped with: a plurality of LEDs disposed lengthwise and widthwise; a substrate on which the plurality of LEDs are mounted; and a light-blocking member configured to prevent a predetermined amount of part of light from passing through, wherein the part of light is part of light emitted from an LED, of the plurality of LEDs, disposed on an outermost circumference and is emitted to an outer circumferential side.

The backlight device of the present disclosure reduces, by using the light-blocking member, an amount of light from the LED which is directed to a liquid crystal panel via a reflection sheet so that the backlight device adjusts an amount of light on a part on which light overlaps on the liquid crystal panel, thereby restraining spot unevenness from occurring.

### BRIEF DESCRIPTION OF DRAWINGS

FIG. 1 is a schematic diagram showing a cross-section of a liquid crystal display equipped with a direct type backlight device according to the conventional art;

FIG. 2 is a schematic diagram of a liquid crystal display showing spot unevenness, on an outer circumference part, to be solved by the present disclosure;

FIG. 3 is a schematic diagram showing a cross-section of an edge part of a backlight device showing a principle of generation of the spot unevenness;

FIG. 4 is a schematic diagram showing a cross-section of an edge part of a backlight device according to the conventional art (black-printed reflection sheet);

FIG. 5 is a schematic diagram showing a cross-section of an edge part of a backlight device according to the conventional art (perforated reflection sheet);

FIG. 6 is an outer view of a backlight device according to a first exemplary embodiment;

FIG. 7 is an exploded perspective view of the backlight device of the first exemplary embodiment;

FIG. 8 is an enlarged view of an edge part of the backlight device of the first exemplary embodiment;

FIG. 9A and FIG. 9B are arrangement plans of LEDs showing “outermost circumferential LEDs” defined in the present disclosure;

FIG. 10 is a schematic diagram showing a cross-section of an edge part according to a first configuration of the backlight device of the first exemplary embodiment;

FIG. 11 is a schematic diagram showing a cross-section of an edge part according to a second configuration of the backlight device of the first exemplary embodiment;

FIG. 12 is a schematic diagram showing a cross-section of an edge part according to a third configuration of the backlight device of the first exemplary embodiment;

FIG. 13 is a schematic diagram showing a cross-section of an edge part according to a fourth configuration of the backlight device of the first exemplary embodiment;

FIG. 14 a schematic diagram showing a cross-section of an edge part according to a fifth configuration of the backlight device of the first exemplary embodiment;

FIG. 15 is a schematic diagram of a reflection sheet according to the fourth and fifth configurations of the backlight device;

FIG. 16 is a schematic diagram showing a cross-section of an edge part according to a sixth configuration of the backlight device of the first exemplary embodiment; and

FIG. 17 is a schematic diagram of a reflection sheet according to the sixth configuration of the backlight device.

### DETAILED DESCRIPTION OF THE PREFERRED EMBODIMENT

An exemplary embodiment will be described below in detail with reference to the drawings as necessary. However, unnecessarily detailed description will be omitted in some cases. For example, a well-known fact and a duplicated explanation of substantially the same configuration will not be described in detail in some cases. This is to prevent the following description from being unnecessarily redundant and to facilitate a person skilled in the art to understand.

The attached drawings and the following description are provided for a person skilled in the art to sufficiently understand the present disclosure, and are not intended to limit the subject matter defined by the claims.

Before the exemplary embodiment is described in the following, the following items will be described to clarify the feature of the present disclosure: (1) A configuration of a direct type backlight device, (2) A relationship between a cost-oriented design method and first and second spot unevenness, (3) A first conventional measure against the second spot unevenness, and (4) A second conventional measure against the second spot unevenness.

### [1. A Configuration of a Direct Type Backlight Device]

In television markets in emerging countries, cost-oriented relatively inexpensive television (TV) sets are being rapidly spread. In order to make television sets for emerging countries more cost-competitive, there is a demand for lower-cost LED backlight devices to be developed. As described above, especially from the point of view of cost, the direct type, which is the direct type, is used as an LED backlight device for a liquid crystal display in a TV or other devices in many cases, and television sets equipped with the backlight device of the direct type are beginning to spread in the emerging country markets.

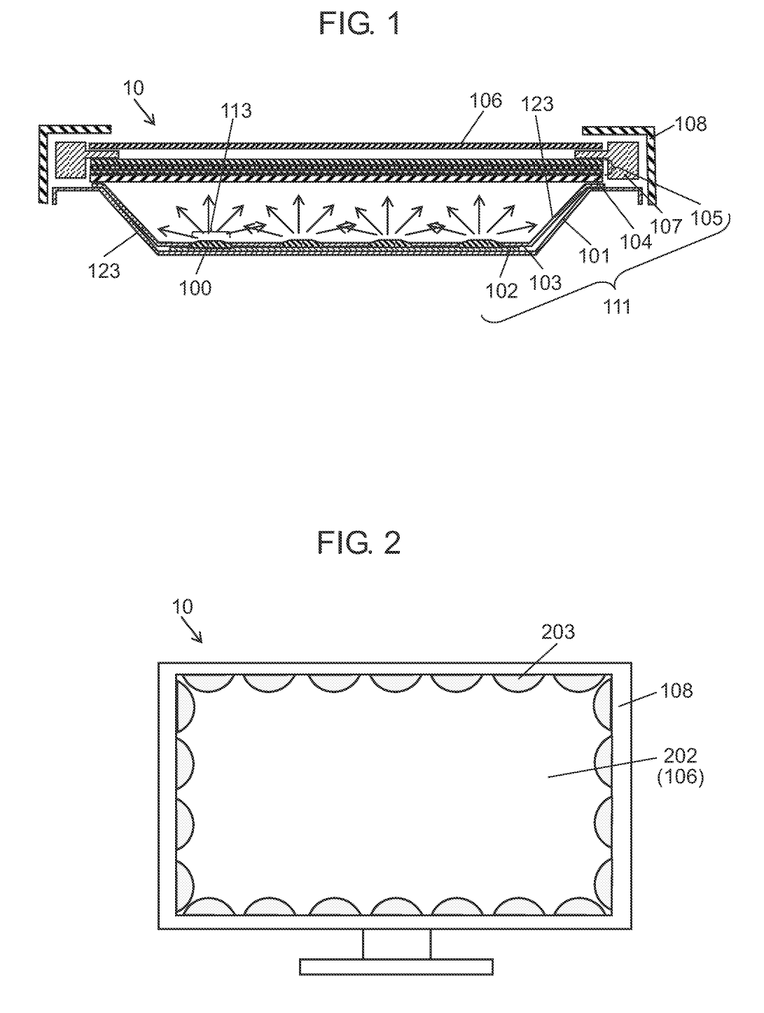

FIG. 1 is a schematic diagram of liquid crystal display 10 equipped with common backlight device 111 of the direct type. Liquid crystal display 10 is equipped with liquid crystal panel 106, cabinet 108, and backlight device 111. Backlight device 111 is equipped with rear frame 101, LED substrate 102 on which LEDs 100 are mounted, reflection sheet 103 having LED holes 113, diffuser plate 104, optical sheet 105, and support frame 107.

Rear frame 101 is located on a rear surface of LED substrate 102 to support LED substrate 102. LED substrate 102 is fixed on rear frame 101 with a double-sided adhesive tape, a bolt, or the like. On LED substrate 102, reflection sheet 103 is mounted such that LEDs 100 are exposed through LED holes 113. Reflection sheet 103 has, in order to deliver light to an edge part of liquid crystal panel 106 and to make the light exit to the front side, inclined parts 123 which is bent to be inclined in vicinities of edges of LED substrate 102.

Diffuser plate 104 is mounted at a position a predetermined distance away from LEDs 100 to play a role of diffusing the light from LEDs 100. Optical sheet 105 is mounted on diffuser plate 104. Optical sheet 105 is formed of a diffuser sheet aiming to diffuse light, a prism sheet aiming to improve brightness, a micro-lens sheet, a reflective polarization sheet, and the like. Regarding a number and configuration of optical sheet 105, various configurations are possible to meet a target specification of the backlight device of the liquid crystal display, and the present disclosure does not limit the configuration of the sheet.

Further, support frame 107 is mounted to fix optical sheet 105 and to fix liquid crystal panel 106. As support frame 107, a molded resin article is widely used, but can be replaced by various materials such as silicone rubber. Further, on an outer side of liquid crystal panel 106 and support frame 107, there is mounted cabinet 108. As materials for cabinet 108, either of a metal component and a resin component can be used. Cabinet 108 is doubled as an outer cabinet at the front-most side of a TV set in many cases and is painted or decorated as an external component.

What is described above is a schematic configuration of liquid crystal display 10 equipped with common direct type backlight device 111. Other than described above, there are used many small components such as a bolt, a double-sided adhesive tape, a cushion, and a conductive tape for electrostatic countermeasure, but these components do not directly relate to the present disclosure and will not be described.

### [2. A Relationship Between a Cost-Oriented Design Method and First and Second Spot Unevenness]

As describe above, the direct type backlight device has an advantage that the cost can be reduced, and especially the number of LEDs largely affects the cost. Therefore, the reduction of the number of LEDs largely contributes to cost-cutting, and is thus one technical point in the direct type backlight device.

In general, it is a thickness of the LED backlight device that closely relates to the number of LEDs. In the direct type backlight device, decrease in the number of LEDs indicates increase in the array pitch (LED pitch) of LEDs 100; therefore, if the LED pitch is large, spot unevenness (light and shade in black and white) of the LEDs is likely to occur.

Further, in the case that the LED pitch and the optical configuration are fixed, the spot unevenness is more likely to occur as the thickness of the LED backlight device is thinner (as LEDs 100 are closer to diffuser plate 104). The distance from LEDs 100 to diffuser plate 104 is commonly called an “optical thickness.” As a result, the technical point is how to reduce the number of LEDs 100 and to control the spot unevenness while keeping the optical thickness of the LED backlight device.

Regarding the spot unevenness, there are some types. One of the typical types is spot unevenness (first spot unevenness) which appears on entire liquid crystal panel 106 and occurs simply depending on the relationship between the LED pitch and the optical thickness. Another one is spot unevenness (second spot unevenness) which appears on an outer circumferential part (edge part) of liquid crystal panel 106 and occurs depending on the relationship among the LED pitch, the optical thickness, a distance from LEDs 100 to inclined part 123 of reflection sheet 103, and an angle of inclined part 123.

In general, the second spot unevenness is more likely to appear; and in many cases, while the LEDs are arranged at a constant pitch, the spot unevenness does not appear in the central part of the screen but occurs in the edge part. FIG. 2 is a front view of liquid crystal display 10 showing the spot unevenness, on the outer circumference part, to be solved by the present disclosure. As shown in FIG. 2, second spot unevenness 203 in semicircular shapes is likely to occur on the edge part in effective display area 202 of liquid crystal panel 106. This spot unevenness 203 has areas brighter than the other area. This second spot unevenness 203 is more noticeable particularly when a white image is displayed on the entire screen.

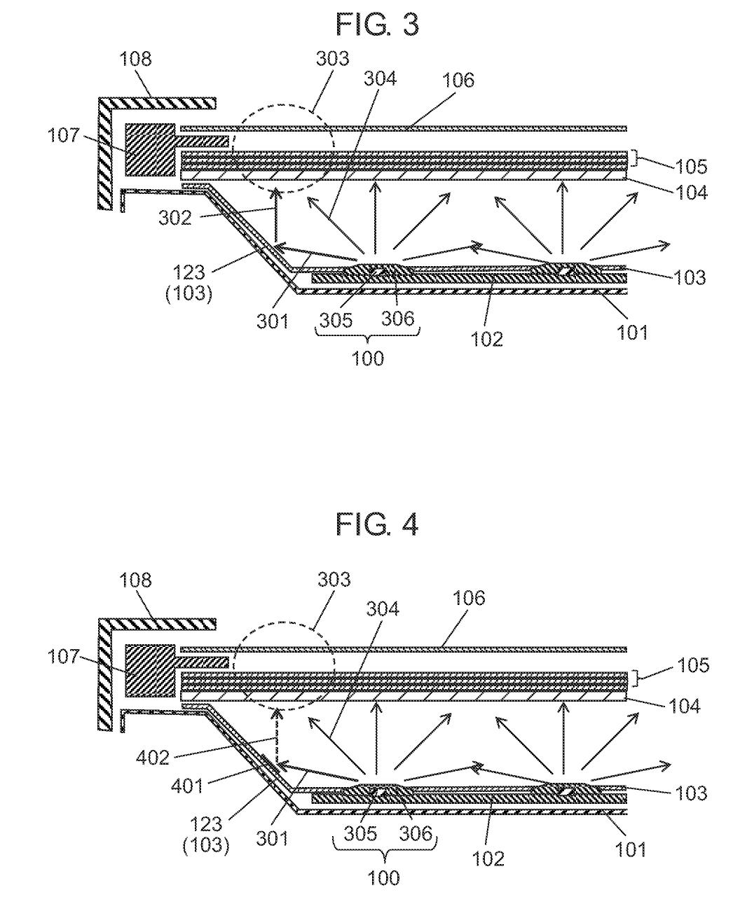

With reference to FIG. 3, a principle of generation of second spot unevenness 203 on the edge part will be described. FIG. 3 is a schematic diagram showing a cross-section in a vicinity of an edge part of common direct type backlight device 111. As shown in FIG. 3, LED 100 is formed of LED package 305 and secondary lens 306. Light emitted from LED package 305 is spread by secondary lens 306 and is radiated. Indirect light 301 of the light radiated from secondary lens 306 is the light directed to inclined part 123 of reflection sheet 103 (to the outer circumferential side of backlight device 111). Indirect light 301 is reflected once on inclined part 123 of reflection sheet 103 to become reflected light 302 and is directed to area 303 of liquid crystal panel 106 just above. To area 303, in addition to reflected light 302, direct light 304, which is directed directly to liquid crystal panel 106 from secondary lens 306, is radiated. Thus, reflected light 302 and direct light 304 overlap each other on area 303 to create a bright spot-shaped area, which causes the spot unevenness.

In order to solve the second spot unevenness, in the conventional art, there are techniques of printing black on and making holes in inclined part 123 of reflection sheet 103. In the following, these two types of conventional arts will be described.

[3. A first Conventional Measure Against the Second Spot Unevenness]

First, the technique of painting black on the reflection sheet will be described with reference to FIG. 4. This technique is to reduce the amount of reflected light 402 reflected on inclined part 123 and directed to area 303 by providing black print 401 on a part of inclined part 123 of reflection sheet 103 as shown in FIG. 4. This arrangement reduces the amount of the light overlapping in area 303, whereby the second spot unevenness is restrained from occurring. However, this technique has mainly two disadvantages. One is that black print 401 needs to be printed on reflection sheet 103 and thus a production cost for the printing is necessary. The other disadvantage is that a color, which is black or similar to black and has low reflectance, is used for black print 401 and thus light is lost being absorbed in the printed part, whereby the brightness is reduced on the outer circumferential part of the TV set. In particular, the latter disadvantage of the decrease in the brightness is a big issue in terms of image quality of the TV, and as a countermeasure against the issue, it is necessary to add an LED or to partially control the supply power to the LEDs; thus, it is not easy to solve the issue.

### [4. A Second Conventional Measure Against the Second Spot Unevenness]

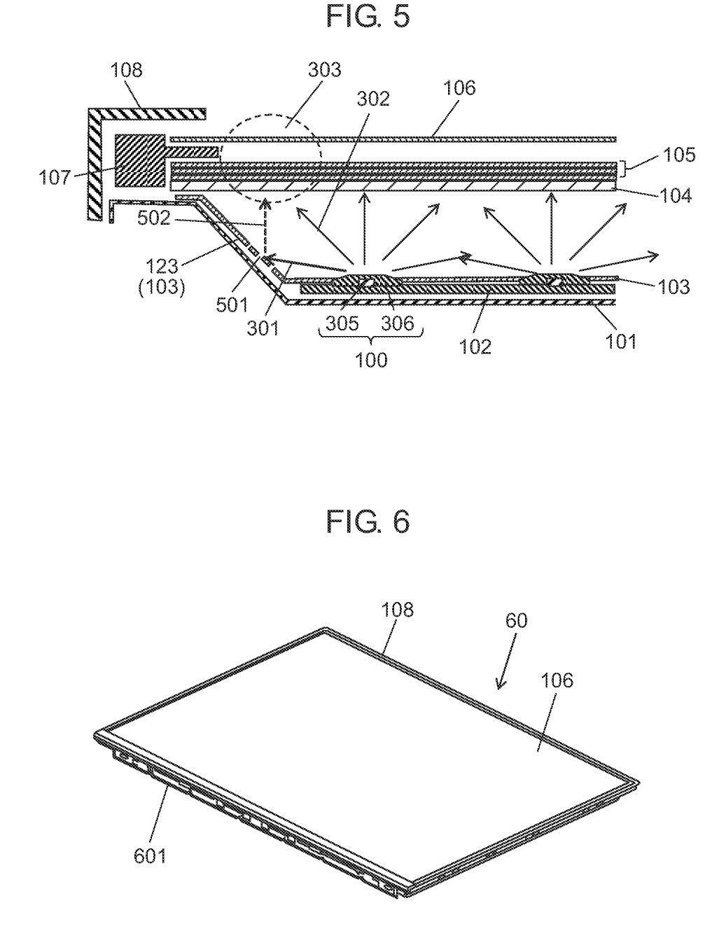

Next, the technique of making holes in reflection sheet 103 will be described with reference to FIG. 5. This technique is to make reflection adjusting holes 501 in a part of inclined part 123 of reflection sheet 103 as shown in FIG. 5 so that the reflection, of indirect light 301, on inclined part 123 is reduced. This arrangement reduces reflected light 502 directed to area 303, whereby the spot unevenness is restrained from occurring. However, this technique uses the same principle as in the above-described first measure, and a part of indirect light 301 is absorbed in reflection adjusting holes 501; therefore, the light is lost, and there is an issue that the brightness is reduced on the same outer circumferential part of the TV set as in the first conventional measure.

In addition, there is an additional issue with this technique that, due to reflection adjusting holes 501 made in inclined part 123 of reflection sheet 103, light leaks from the rear surface and that dust or small bugs enter. Particularly with the issue of the dust and the bugs entering, if the dust or the bug once enters in the backlight device, it is impossible to remove the dust or the bug without disassembling, and in addition, the dust or the bug is projected on the screen, which directly leads to a serious problem. However, different from the case of black print 401 in the first conventional measure, reflection adjusting holes 501 can be made simultaneously when LED holes 113 are made in reflection sheet 103; therefore, cost does not increase in many cases.

As describe above, when the second spot unevenness is solved by the conventional arts described in the first and second conventional measures, the following three issues arise as side effects. Specifically, the issues are (1) the decrease in the brightness, due to the loss of light, on the outer circumferential part of the TV set, (2) the increase in cost of the reflection sheet and (3) the decrease in the image quality due to the dust or the bug entering.

The present disclosure is to solve these three issues and will be described below through an exemplary embodiment.

### First Exemplary Embodiment

In the following, a first exemplary embodiment will be described with reference to FIGS. 6 to 17.

### [5-1. Configuration]

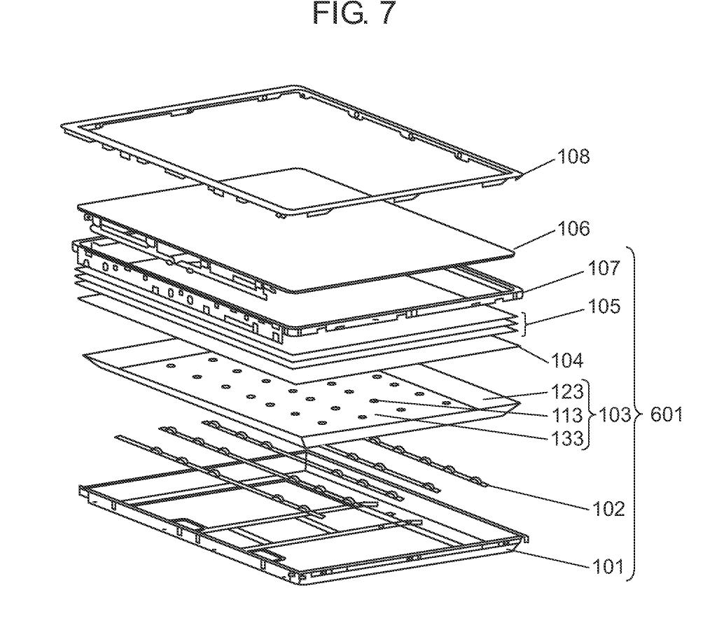

First, a configuration of a backlight device according to the first exemplary embodiment will be described with reference to the drawings. FIG. 6 is an outer view of liquid crystal display 60 equipped with backlight device 601 according to the first exemplary embodiment, and FIG. 7 is an exploded perspective view of liquid crystal display 60 equipped with backlight device 601.

As shown in FIG. 6, liquid crystal display 60 is equipped with liquid crystal panel 106, cabinet 108, and backlight device 601. As shown in FIG. 7, backlight device 601 is equipped with support frame 107, optical sheet 105, diffuser plate 104, reflection sheet 103, LED substrate 102, and a rear frame 101.

Cabinet 108 is a frame part, which is the outermost layer at the front side of a TV set. In general, many TV sets are made of resin, but some are made of metal. Liquid crystal panel 106 is made of two glass plates laminated with liquid crystal sealed between the plates.

Support frame 107 is a component for supporting liquid crystal panel 106 and at the same time supporting optical sheet 105 and diffuser plate 104 located under liquid crystal panel 106. Optical sheet 105 is selected depending on a target image quality of a TV set, and various combinations can be used. Typical examples include diffuser sheets, prism sheets, reflective polarization sheets, and micro-lens films, and brightness and a viewing angle are adjusted depending on how these components are combined. Diffuser plate 104 is made of resin, and examples include one having reflective beads inside to obtain a diffusion function and one having voids inside to obtain a diffusion function.

As shown FIG. 7, reflection sheet 103 is formed of rectangular flat portion 133, and inclined parts 123 which are formed to be inclined from four sides of flat portion 133 to liquid crystal panel 106. In flat portion 133 of reflection sheet 103, there are formed LED holes 113 through which LEDs 100 are exposed from reflection sheet 103. In many cases, reflection sheet 103 which is white in color and has a reflectance of 90% or higher is used.

On LED substrate 102 are mounted LED packages 305 and secondary lenses 306. Rear frame 101 can be made of resin or metal. In general, since when a resin rear frame is used, dissipation of heat of the LEDs is poor, a metal rear frame is often used. In the above, the configurations and the materials of the components of the present exemplary embodiment are described; however, the present disclosure does not limit the configurations or the materials.

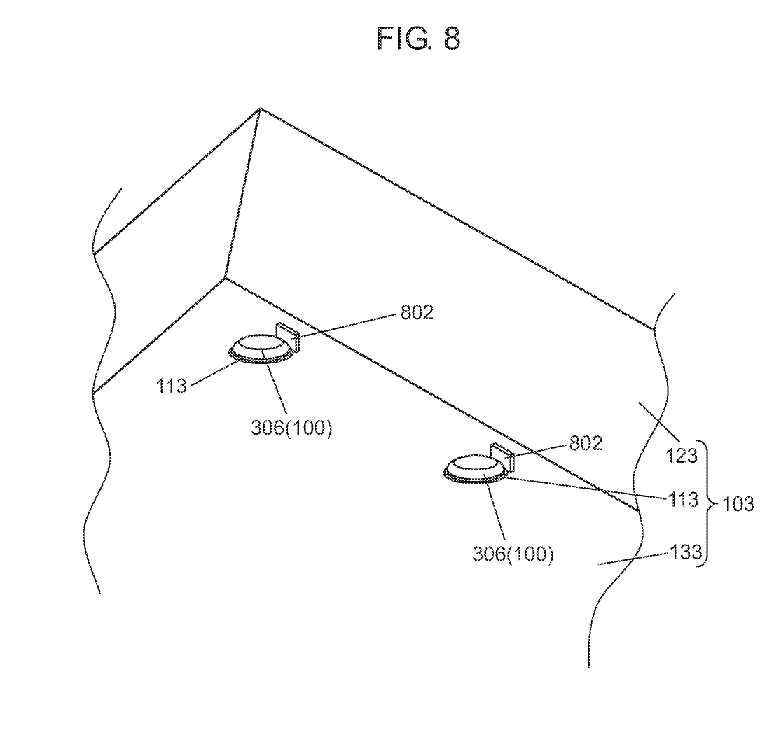

FIG. 8 is an enlarged view of an edge part of backlight device 601. With reference to FIG. 8, a structural feature of backlight device 601 of the present disclosure will be described. Secondary lenses 306 of LEDs 100 are exposed through LED holes 113 formed in flat portion 133 of reflection sheet 103. On inclined part 123 side from LEDs 100 are provided light-blocking members 802. Light-blocking members 802 have a rectangular shape and are formed on flat portion 133 of reflection sheet 103. Light-blocking members 802 reduce indirect light 301 directed from LEDs 100 to inclined part 123. Light-blocking members 802 are provided in the vicinities of at least outermost circumferential LEDs 100.

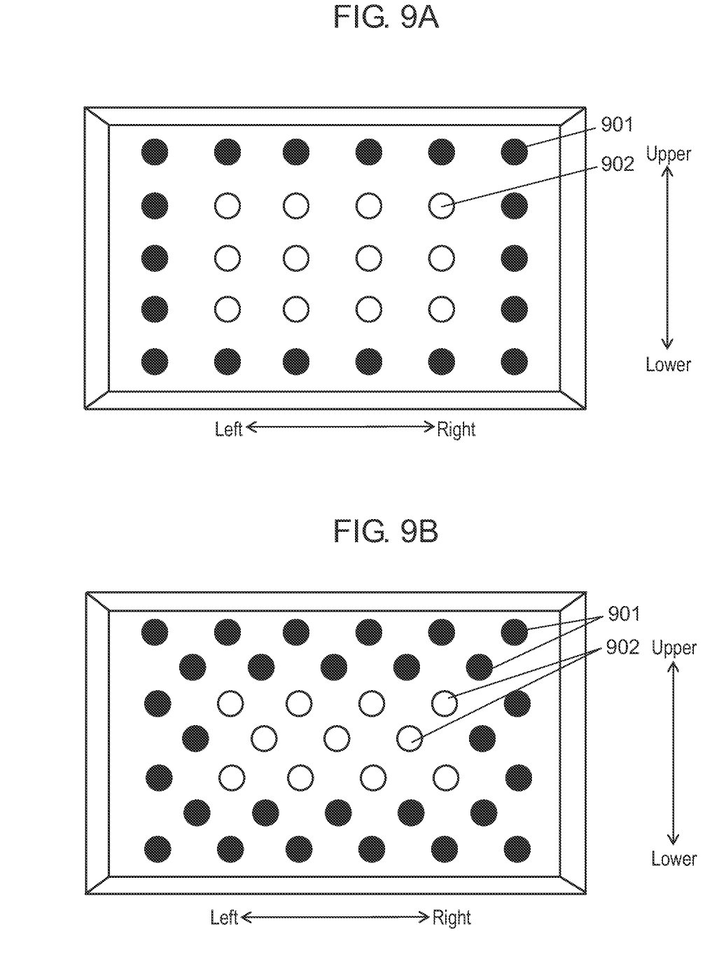

Here, the outermost circumferential LEDs will be described with reference to FIG. 9A and FIG. 9B. FIG. 9A and FIG. 9B shows examples of an arrangement of LEDs 100 when the TV set is viewed from the front. Because a number and the arrangement of LEDs 100 depend on a TV set, the present disclosure does not limit the positions or the number of the LEDs. The black circles in FIG. 9A and FIG. 9B represent outermost circumferential LEDs (outer LEDs 901), and the white circles represent the other LEDs (inner LEDs 902). As shown in FIG. 9A and FIG. 9B, LEDs 100 which are seen in the front row when the LEDs are viewed from the edge side correspond to the outermost circumferential LEDs in the present disclosure. Therefore, when the LEDs are arranged in a staggered arrangement as shown in FIG. 9B, LEDs 100 located slightly inward also correspond to the outermost circumferential LEDs.

The second spot unevenness tends to be more noticeable as the distance from LEDs 100 to inclined part 123 of reflection sheet 103 is smaller. Therefore, depending on the designed value of the distance, in some cases, the second spot unevenness occurs on the upper and lower edge parts of the liquid crystal display but does not occur on the left and right edge parts, for example. In that case, if light-blocking members 802 shown in FIG. 8 are provided only for upper and lower outermost circumferential LEDs 100, it provides an effect of controlling the spot unevenness. Specifically, light-blocking members 802 only have to be disposed on the place where LEDs 100 are close to the edge part so that the second spot unevenness occurs noticeably.

### [5-1-1. A First Configuration of the Light-Blocking Member and an Operation]

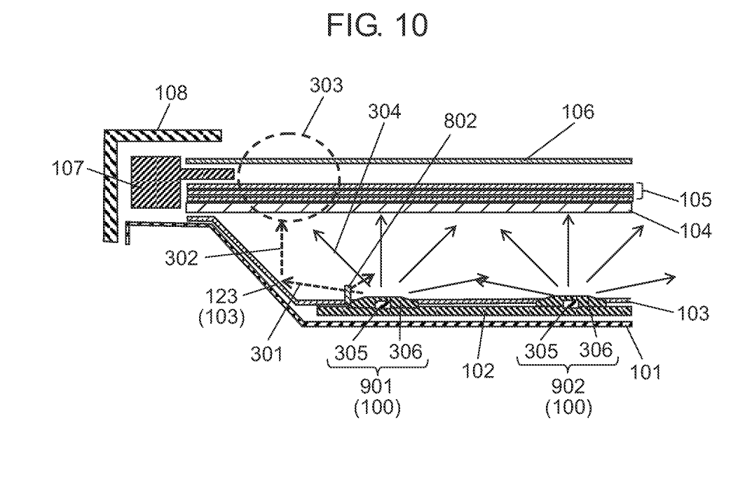

With reference to FIG. 10, description will be made on an optical path and a principle of restraint of the second spot unevenness when light-blocking members 802 are disposed. FIG. 10 is a schematic diagram showing a cross-section of the edge part of backlight device 601 for illustrating a first configuration of the light-blocking member.

In the first configuration, light-blocking members 802 are disposed on an inclined part 123 side from outer LEDs 901 as shown in FIG. 10. Light-blocking members 802 reduce indirect light 301 directed to inclined part 123 of reflection sheet 103 so that an amount of reflected light 302 directed to area 303 can be reduced. Regarding the size and the shape of light-blocking member 802, the size is preferably about the same as or smaller than a size of secondary lens 306. However, the size and the shape can be set depending on an optical thickness of backlight device 601, the distance from outer LEDs 901 to the edge part, and an arrangement pitch of LEDs 100; and the present disclosure does not limit the size.

Regarding a color of light-blocking members 802, various colors can be used, but a high-reflectance color such as white and silver or a specular surface is desirable. A color such as whitish brown, which reflects light and at the same time transmits part of the light, is also desirable. If a color such as black, which absorbs light, is used, light is lost, whereby the brightness on the edge part is reduced.

As a material for light-blocking members 802, heat resistant materials are preferable because light-blocking members 802 are disposed in the vicinities of LEDs 100. Materials which become discolored or deforms due to application of heat are not preferable.

Light-blocking members 802 of the first configuration are provided to flat portion 133 of reflection sheet 103. Since flat portion 133 has a flat surface, light-blocking members 802 can be easily mounted; therefore, this arrangement is preferable.

### [5-1-2. A Second Configuration of the Light-Blocking Member and an Operation]

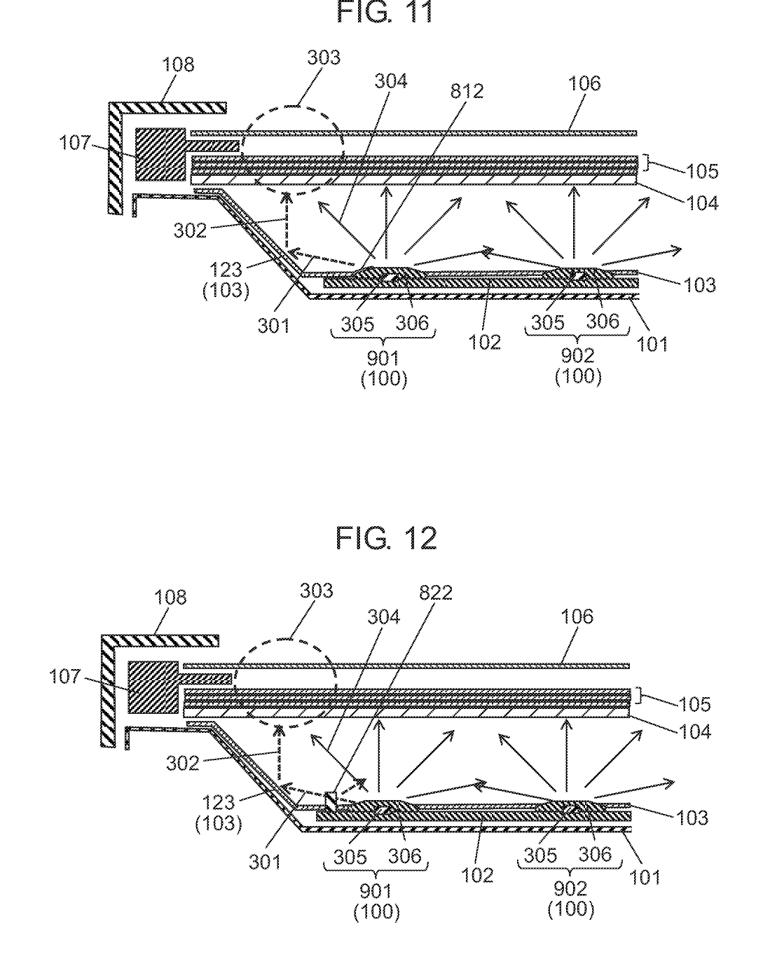

FIG. 11 is a schematic diagram showing a cross-section of the edge part of backlight device 601 for illustrating a second configuration of the light-blocking members. With reference to FIG. 11, light-blocking members 812 are each provided to the surface on the inclined part 123 side of each secondary lens 306 of outer LEDs 901. As materials for light-blocking members 812, reflection tapes can be used. Reflection tapes or other components applied, on secondary lenses 306, as light-blocking members 812 can reduce indirect light 301 directed to inclined part 123 and can thus reduce an amount of reflected light 302 directed to area 303; thus, the second spot unevenness is restrained from occurring.

Alternatively, light-blocking members 812 may be provided on or inside secondary lenses 306. For example, light-blocking members 812 may be configured such that the surfaces of secondary lenses 306 are colored or roughened to reduce transmittance. However, because, from the point of view of cost, it is generally preferable to use the same secondary lenses 306 for all the LEDs used in the backlight device, the former means is more preferable than the latter one.

Also as light-blocking members 812, in the same way as in the case of light-blocking members 802 of the first configuration shown in FIG. 10, there are preferably used components which are in light-reflecting white color or silver color and are excellent in heat-resistance. Since light-blocking members 812 are formed of tapes or formed by machining, the material cost can be low.

### [5-1-3. A Third Configuration of the Light-Blocking Member and an Operation]

FIG. 12 is a schematic diagram showing a cross-section of the edge part of backlight device 601 for illustrating a third configuration of the light-blocking member. In the third configuration, light-blocking members 822 are mounted on the inclined part 123 side from outer LEDs 901 on LED substrate 102 and are protruded to a liquid crystal panel 106 side through holes formed in reflection sheet 103.

As a material for light-blocking member 822, preferable is a component which is made of resin and which is of a type capable of being clamped on LED substrate 102, a dummy chip (which is not conductive and does not affect electric characteristics of LED substrate 102), or others. Since light-blocking members 822 of the third configuration can be mounted on LED substrate 102 simultaneously when LED packages 305 and secondary lenses 306 are mounted, the process cost can be relatively low.

### [5-1-4. A Fourth Configuration of the Light Blocking Member and an Operation]

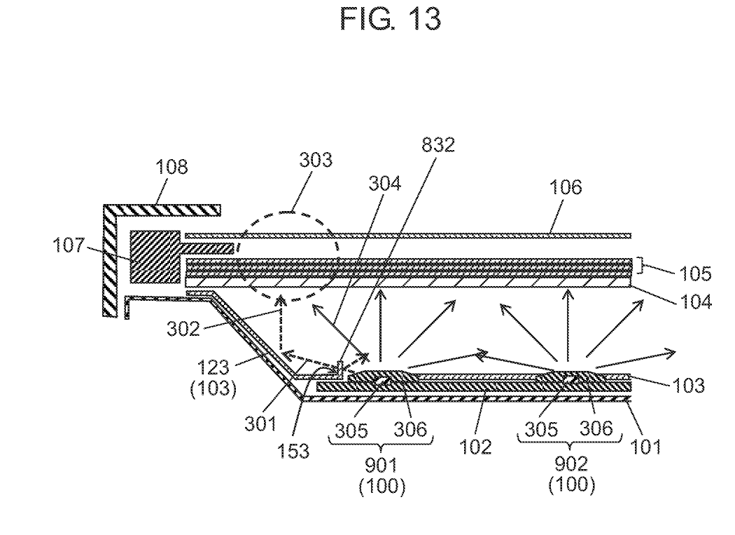

FIG. 13 is a schematic diagram showing a cross-section of the edge part of backlight device 601 for illustrating a fourth configuration of the light-blocking member. With reference to FIG. 13, light-blocking members 832 are each made of a part of reflection sheet 103 such that the part is bent. Light-blocking members 832 are made of the parts of reflection sheet 103 bent, on the inclined part 123 side from outer LEDs 901, to the liquid crystal panel 106. If reflection sheet 103 is made easy to be bent, for example, by making a dashed-line perforation at the position at which reflection sheet 103 is bent, it is preferable because workability is thus improved.

### [5-1-5. A Fifth Configuration of the Light Blocking Member and an Operation]

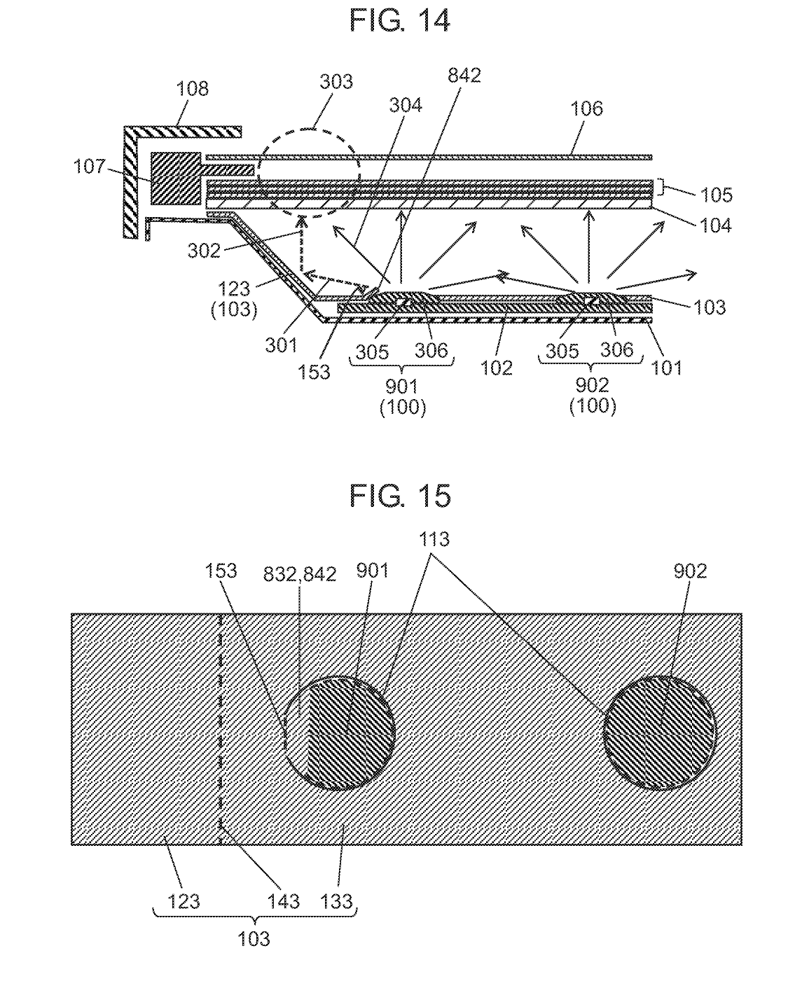

FIG. 14 is a schematic diagram showing a cross-section of the edge part of backlight device 601 for illustrating a fifth configuration of the light-blocking member. As shown in FIG. 14, light-blocking member 842 of the fifth configuration is formed on the inclined part 123 side from outer LED 901 so as to overlap outer LED 901. The bending angle of light-blocking members 842 is different from the bending angle of light-blocking members 832 shown in the fourth configuration. Specifically, light-blocking members 842 are lift up by outer LEDs 901 exposed through LED holes 113 and are thus bent along outer surfaces of outer LEDs 901.

With this arrangement, the light once reflected on light-blocking members 842 is returned again back into secondary lenses 306 of outer LEDs 901. Because the surface of LED substrate 102 is typically in white color, the light having returned into secondary lenses 306 is reflected on the surface of substrate 102 and is emitted again through secondary lenses 306 while being spread. This arrangement provides an effect that the second spot unevenness is not likely to occur.

FIG. 15 is a cut-out view of the reflection sheet 103 of the fourth and fifth configurations of the light-blocking member. As shown in FIG. 15, LED holes 113, through which outer LEDs 901 and inner LEDs 902 are exposed, are formed in reflection sheet 103. Of the holes, on the inclined part 123 side of LED holes 113 through which outer LEDs 901 are exposed, the parts corresponding to light-blocking members 832 or 842 are formed. In other words, LED holes 113 are formed, leaving the parts corresponding to light-blocking members 832 or 842 on reflection sheet 103.

With this arrangement, the shape of light-blocking members 832 can be simultaneously formed in a punching step of forming LED holes 113; therefore, additional material cost or processing cost is not necessary to provide light-blocking members 832, thereby providing advantages in cost. Further, since reflection sheet 103 is bent and used, a step of providing a dashed-line perforation in bending part 143 is commonly included. Thus, it is possible to provide a dashed-line perforation also in bending parts 153 of light-blocking members 832 in this step.

Although light-blocking members 832 shown in the fourth configuration are previously bent in a bending step at bending parts 153 shown in FIG. 15 and is then mounted on LED substrate 102, light-blocking members 842 shown in the fifth configuration does not need such a bending step. Light-blocking members 842 shown in fifth configuration are lift up by outer LEDs 901 which are being inserted into LED holes 113 and are thus automatically bent at bending parts 153 when reflection sheet 103 is mounted on LED substrate 102.

### [5-1-6. A Sixth Configuration of the Light Blocking Member and an Operation]

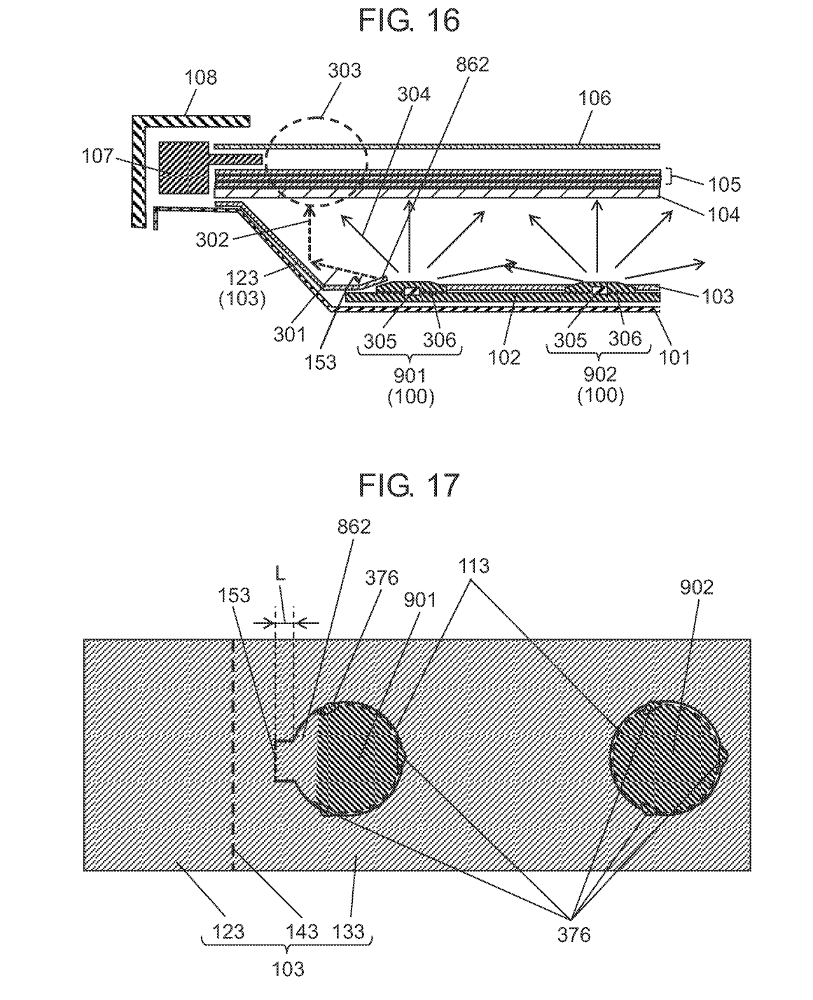

Next, a sixth configuration will be described with reference to FIG. 16 and FIG. 17. FIG. 16 is a schematic diagram showing a cross-section of the edge part of backlight device 601 for illustrating the sixth configuration of the light-blocking member. As shown in FIG. 16, light-blocking members 862 of the sixth configuration are formed to overlap outer LEDs 901 as in the same way as light-blocking members 842 of the fifth configuration shown in FIG. 14. However, bending parts 153 of light-blocking members 862 are each formed at a position further away from an end part on the inclined part 123 side of each outer LED 901 than bending parts 153 of light-blocking members 842. Therefore, a slope of light-blocking members 862 is gentler than a slope of light-blocking members 842 shown in FIG. 14.

FIG. 17 is a schematic diagram of a reflection sheet according to the sixth configuration of the light-blocking member. As shown in FIG. 17, bending parts 153 of light-blocking members 862 are each formed at a position a predetermined distance L away, to the inclined part 123, from the end part of LED hole 113 of each outer LED 901.

As shown in FIG. 17, on each secondary lens 306 are provided claws 376 at a plurality of positions to fix reflection sheet 103. These claws 376 securely fix reflection sheet 103 between secondary lenses 306 and LED substrate 102 so that reflection sheet 103 can be prevented from lifting up. In the case that light-blocking members 832 are made of reflection sheet 103 in the vicinities of the LEDs as shown in FIG. 15, a bending step needs to be included to previously bend light-blocking members 832. The reason is as follows: even in the case that dashed lines for bending is provided at bending part 153, if reflection sheet 103 is forced to be hitched to claws 376 while parts of LED holes 113 are blocked by light-blocking members 842, it causes reflection sheet 103 to lift up or makes it difficult to mount reflection sheet 103.

In addition, it is not easy for a worker to bend, in an actual mass production process, light-blocking members 842 at such an angle that light-blocking members 842 overlap secondary lenses 306 as in the fifth configuration shown in FIG. 14, and a certain level of skill and a certain amount of man-hours are necessary. These issues are solved by light-blocking members 862 shown in FIG. 16 and FIG. 17.

Since bending parts 153 of light-blocking members 862 are each formed away from each LED hole 113, when reflection sheet 103 is put on LEDs 100, light-blocking members 862 can be automatically bent, and can automatically form a structure in which light-blocking members 862 overlap secondary lenses 306 as shown in FIG. 16. In addition, a force which helps reflection sheet 103 to lift up after reflection sheet 103 is mounted on claws 376 is reduced.

Specifically, there is no need for the step in which a worker bends light-blocking members 862 to mount reflection sheet 103, and the structure in which light-blocking members 862 overlap secondary lenses 306 is thus formed stably; therefore, backlight device 601 equipped with this light-blocking member 862 can be manufactured in the same work as in the conventional process.

With the arrangement described above, light-blocking member 862 can be made simultaneously in the conventional working process of the reflection sheet, and the present disclosure is preferable in this respect. Further, since light-blocking members 832, 842, and 862 formed by using reflection sheet 103 shown in the fourth to sixth configurations are commonly a reflective sheet or a sheet in white color or silver color, there is no need for additional coloring, and there is no need for material cost for a separate component, thereby providing advantages in cost.

### [5-2. Advantageous Effect and the Like]

As described above, backlight device 601 of the present disclosure is equipped with: a plurality of LEDs 100 disposed lengthwise and widthwise; LED substrate 102 on which the plurality of LEDs 100 are mounted; and light-blocking members 802, 812, 822, 832, 842, and 862 configured to prevent a predetermined amount of part of light from passing though, wherein the part of light is part of light emitted from outer LEDs 901, of the plurality of LEDs 100, disposed on an outermost circumference and is emitted to an outer circumferential side. With this arrangement, a light amount of indirect light 301 directed to inclined part 123 of reflection sheet 103 is reduced; thus, a light amount on a part on which light overlaps on liquid crystal panel 106 is reduced, whereby the second spot unevenness is eliminated without reducing the brightness on the edge part.

In addition, when light-blocking member is made of high-reflectance material which is in white or silver in color, reflected light is not absorbed, whereby light is not lost.

Further, when light-blocking member is made by using a part of reflection sheet 103, which reflect light from LEDs 100, no additional members are necessary. Further, it is not necessary to make a special hole such as reflection adjusting hole 501 in reflection sheet 103, and therefore, dust or small bugs do not enter.

As described above, by using the light-blocking member of the present disclosure, it is possible to eliminate the second spot unevenness without causing the side effect occurring in the conventional art shown in FIG. 4 and FIG. 5. Therefore, the second spot unevenness can be eliminated without raising cost or reducing brightness of the edge part, and it is thus possible to manufacture liquid crystal TVs which are lower in cost and high quality. The present disclosure can be expanded, although there are differences among embodiments, to almost all direct type LED backlight devices.

In addition, since there is a technical trend that the number of LEDs used will be further reduced along with the spread of flip-chip in the future, the expansion of the present disclosure is thought to be accelerated.

The present disclosure can be applied to a direct type LED backlight device in which LEDs are laid out lengthwise and widthwise just under the screen and to a liquid crystal display in a liquid crystal television, a liquid crystal display monitor, and the like.

What is claimed is:

1. A backlight device comprising:
a plurality of LEDs disposed lengthwise and widthwise;
a substrate on which the plurality of LEDs are mounted;
a light reflection sheet configured to reflect light emitted from the plurality of LEDs; and
a light-blocking member configured to prevent a predetermined amount of part of light from passing through, wherein the part of light is part of light emitted from an LED, of the plurality of LEDs, disposed on an outermost circumference and is emitted to an outer circumferential side.

2. The backlight device of claim 1, wherein each of the plurality of LEDs is equipped with a secondary lens.

3. The backlight device of claim 1, wherein the light-blocking member is in white color or silver color.

4. The backlight device of claim 1, wherein the light-blocking member is formed of the reflection sheet.

5. The backlight device of claim 4, wherein the reflection sheet has holes in which the LEDs are disposed, and
the light-blocking member is formed at parts of some of the holes.

6. The backlight device of claim 2, wherein the light-blocking member is provided on the secondary lens or inside the secondary lens.

7. The backlight device of claim 1, wherein the light-blocking member is provided to the substrate.

8. The backlight device of claim 2, wherein the light-blocking member is formed to overlap the secondary lens.

9. A liquid crystal display comprising:
the backlight device of claim 1; and
a liquid crystal display panel.
